(19) United States
(12) Patent Application Publication
(10) Pub. No.: US 2020/0311744 A1
(43) Pub. Date: Oct. 1, 2020

(54) Verification Device for a Cold Chain of Custody

(71) Applicant: Michael Soderman, Falkensee (DE)

(72) Inventor: Michael Soderman, Falkensee (DE)

(21) Appl. No.: 16/813,773

(22) Filed: Mar. 10, 2020

Related U.S. Application Data
(60) Provisional application No. 62/824,326, filed on Mar. 27, 2019.

(51) Int. Cl. G06Q 30/00

(52) U.S. Cl. CPC G06Q 30/0185

(57) ABSTRACT

A transparent unit firmly attached to a product or packaging of a product—or part of the packaging itself—that has to be cooled in a continuous cooling chain. This unit can indicate a break in the continuous cooling chain—with obstacles to manipulation or recreation of the initial status—via the melting of a solid into a liquid, thereby destroying a pattern that was created in the solid, for instance by stamping or carving, or that was formed by a mold, or thereby destroying individual elements that lose their arrangement upon the melting of the solid. Any person further along in the cooling chain will be able to see that the cooling chain was broken, and will know that manipulation to recreate a given pattern is difficult. Various additives can be used to lower or raise the melting point of the solid.

### CROSS REFERENCE TO RELATED APPLICATIONS

This application claims the priority of the provisional application 62/824,326 filed on Mar. 27, 2019.

### BACKGROUND

The invention is in the field of cold chains of various products such as frozen food, cooled food and pharmaceutical and chemical products, and relates to an inexpensive way of validating compliance with cold-chain requirements along every step of the chain, in particular for an end consumer who may not have any access to cold chain logs or the like.

Ensuring adherence to cold-chain requirements is very important; otherwise, for instance, food can spoil and pharmaceutical products can lose their effectiveness or even become dangerous. Verification of the cold chain and prevention of manipulation are therefore also very important.

Verification is frequently done via automated or manual logs with regard to handling and thermal testing while the product is being passed along. Products are shipped in refrigerated vehicles or in insulated containers and held in refrigerated warehouses at intermediate and end points. Temperature data loggers and RFID tags can be used to monitor temperatures in the shipping vehicle and warehouse. Documentation can be used at every point in the process, with someone signing off every time the product is passed along.

Problems can arise here because it may be difficult to detect if a food or pharmaceutical product has thawed out to some extent and then refrozen at some point in transit or storage. In particular documentation can be falsified, but temperature data loggers could also be manipulated or be in a different place than the product at some point. Whether or not logging, documentation and temperature testing are used during the transportation and storage of cold chain products, the end consumer may have no way to tell if the product was really kept at the proper temperature during the entire transportation and storage process. End consumers typically have no access to logs or documentation of this type.

Even if there has been compliance with cold-chain requirements over the entire transportation and storage route, employees at the end point in a supermarket, for instance, may be careless in leaving frozen products out in a warm environment for too long and, if they are frozen once again, the end consumer has no way to tell that this has taken place—until an episode of food poisoning arises, for example. Shoppers at the supermarket may decide not to purchase a frozen product and simply leave it somewhere outside of the freezer—to simply be put back into the freezer when discovered by a store employee.

### SUMMARY

The invention relates to an inexpensive and transparent unit firmly attached to a product or packaging of a product—or part of the packaging itself—that has to be cooled in a continuous cooling chain. This unit can indicate a break in the continuous cooling chain—with obstacles to manipulation or recreation of the initial status—via the melting of a solid into a liquid, thereby destroying a pattern that was created in the solid, for instance by stamping or carving, or that was formed by a mold, or thereby destroying individual elements that lose their arrangement upon the melting of the solid. Any person further along in the cooling chain will be able to see that the cooling chain was broken, and will know that manipulation to recreate a given pattern is difficult. Various additives can be used to lower or raise the melting point of water, for instance, if ice is used as the solid, or of another solid/liquid combination.

### DETAILED DESCRIPTION

The problem involved here is to provide an inexpensive method for persons in a cold chain—but in particular end consumers who may not have access to logs or electronic information stored during the cold chain—to easily determine whether a product has been subject to temperatures higher than mandatory upper limits during transport and storage of that product.

This problem is solved via the transparent unit attached to the product as further described below and as shown in the drawings.

In a general sense, a solid is provided in a clear unit attached to the product that melts into a liquid when a certain temperature has been exceeded for a specified period of time. The melting point can be set very precisely via the use of specific compounds and additives that will melt at a particular temperature and at a particular rate.

The clear unit attached to the product can be attached to the outside of the product or be inside the product packaging with a clear “window” showing at one of the surfaces of the product packaging. The clear unit can either be attached in some way to the product or product packaging, or be an integral part of the product packaging or simply travel along with the product, with consideration given to preventing manipulation underway via a separation of the clear unit and the product.

The basic principle is that a solid is in the transparent unit that melts at a specific temperature and at a specific rate, indicating that requirements of a cold chain have not been met, and the newly created liquid cannot be easily returned to the specific solid (for instance with a particular pattern in the solid) that melted. Manipulation can be prevented in that way.

A pattern could be stamped into the solid material at the beginning of the cold chain, or a pattern could be created in another way, for instance via carving or cutting. The solid could be formed around a mold with a particular pattern. Unattached elements could be placed in the solid (for instance ice) that form a pattern or logo. Upon melting, the unattached elements would fall into the liquid in random ways, and recreation of the specific pattern or logo would be very difficult.

If the required melting point is at the melting point of ice, and the melting time is not critical, ice/water could simply be used as the solid/liquid combination. The pattern or arrangement of elements can simply be created in the ice or water that is freezing into ice at the beginning of the cold chain, for instance in the product factory.

When different melting temperatures or melting rates are required, additives could be added to the initial water. The type of additive and the concentration in the ice/water will change the melting point and rate to a specific level. Alternatively, other types of solids/liquids can be used.

To lower the melting point, antifreeze (ethylene glycol) could be added in various concentrations. It is well known that a 50/50 mixtures of water and ethylene glycol, for instance, will lower the melting point of water to −35° F. Lower concentrations of ethylene glycol, down to 0%, will create melting points between −35° F. (or 37.22° C.) and 32° F. (or 0° C.). Any solute that will dissolve in water will also lower the freezing point—sea water, for instance, has a freezing/melting point of roughly −2° C., depending on the concentration of salt and other impurities.

Solid/liquid combinations other than ice/water can, of course, also be used. Glycerol, as an example, has a freezing/melting point at 17.8° C. Sulfuric acid has a freezing/melting point of 10.3° C. The particular substance that is used will depend on the specific circumstances. Water is inexpensive and non-caustic and will therefore be a popular choice for products that have to be kept below the freezing point of water.

The transparent unit could simply travel with the product to be monitored, but possibilities for manipulation are obvious. The transparent unit could be an integral part of the packaging for the product, with only a “window” showing in some part of the surface of the packaging, or could be attached via adhesives/tapes, or slots/tabs or screws/bolts/rivets or welding (e.g. plastic or ultrasonic or thermal) or interference fits or inserts or elastomer bands/O-rings or any other way that a person skilled in the art of attaching products can devise.

Additional elements could be attached to the transparent unit or the transparent unit+product packaging combination to prevent manipulation, for instance a band surrounding the transparent unit or seals or parts that deform or break when the transparent unit is removed.

### BRIEF DESCRIPTION OF THE DRAWINGS

The following are shown in the accompanying drawings:

FIG. 1 shows a transparent unit (3) containing a solid/liquid substance (4) attached (1) to the surface of product packaging (2);

FIG. 2 shows a top-down view of the transparent unit of FIG. 1 (3) with a pattern (5) in the solid in the transparent unit, which is attached to the surface of product packaging (2);

FIG. 3 shows a top-down view of the transparent unit of FIG. 1 (3) with a collection of loose elements (6) forming a pattern or logo, here the letter “H”, in the solid in the transparent unit, which is attached to the surface of product packaging (2).

### DETAILED DESCRIPTION OF THE PREFERRED EMBODIMENTS

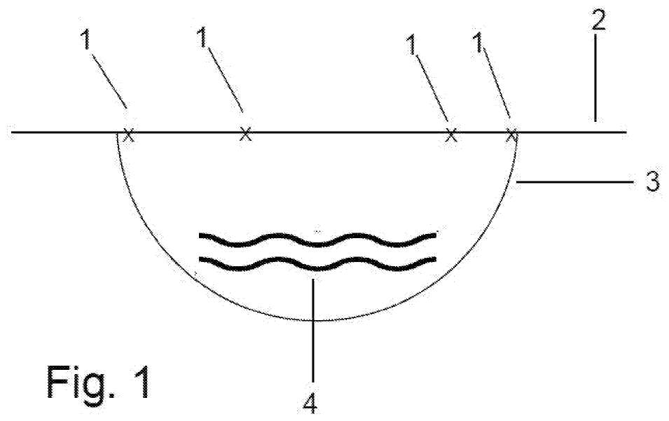

FIG. 1 shows a transparent unit (3), here a sealed plastic bubble, that can either be viewed as being attached to the product surface via attachment means (1) or, if the attachment means are eliminated and the transparent unit is an integral whole with the packaging, as having a window towards the outside (straight/top part of the transparent unit) with the curved portion of the transparent unit going deeper into the product or product packaging. The solid (4) can be created, and a pattern can be introduced into the solid, in the factory during the packaging phase. Ice/water can be used as the solid/liquid combination in this example. The ice will retain a pattern cut into it, or formed via a mold, or introduced in other ways discussed in this specification, as long as it stays below the freezing point in the cold chain. If the product is subjected to temperatures above the freezing point (0° C. or 32° F.) somewhere in the cold chain, the ice will melt and the pattern will be destroyed. A complicated pattern cannot easily be reproduced by someone intending to cover up the fact that the product was in an environment with temperatures above the freezing point.

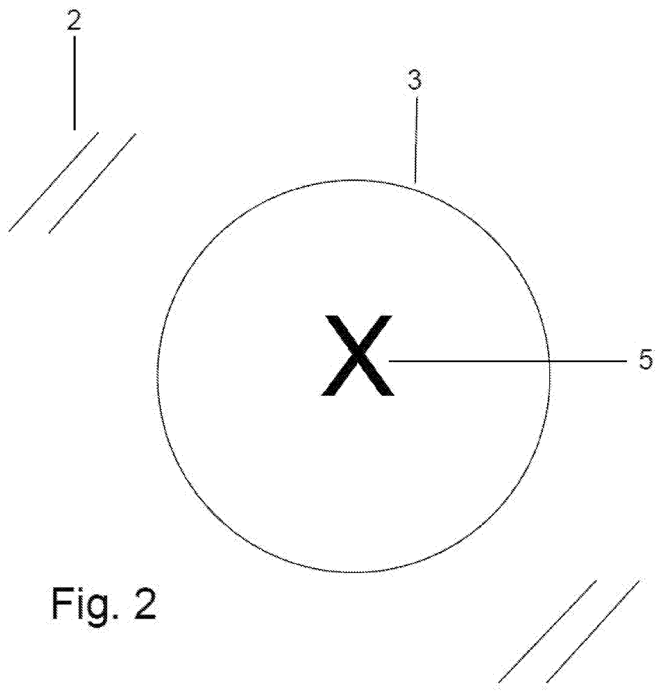

FIG. 2 shows a transparent unit, here a sealed plastic bubble, with an explicit pattern (here the letter X) introduced into the solid. In practice, a more complicated pattern—that cannot be reproduced in a refrozen solid without great difficulty—would be used to prevent manipulation. The transparent unit can also be attached to the product or product packaging in such a way that an attempted replacement of the transparent unit would readily become evident.

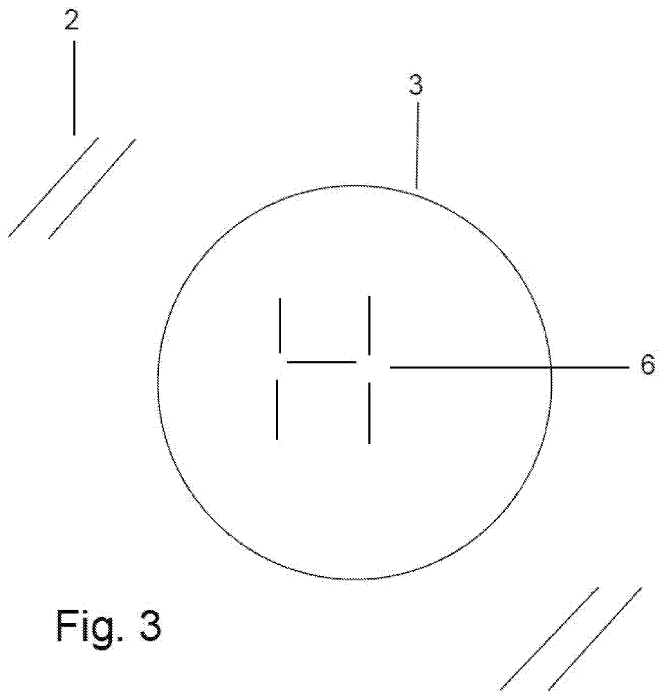

FIG. 3 shows a transparent unit with individual elements forming an “H” pattern. In practice, a more complicated arrangement of individual elements would be used. When the solid melts, the specific placement/arrangement of the elements is destroyed, and it would be very difficult to place the elements in their original configuration to reproduce the pattern/logo.

### LIST OF REFERENCE NUMERALS

1 Attachment means

2 Surface of the product packaging

3 Transparent unit

4 Solid/liquid in the transparent unit

5 Pattern created in the solid

6 Pattern/logo created in the solid out of unattached elements

1. A verification device comprising a transparent unit containing solid material that melts into a liquid when a specified temperature has been exceeded for a specified period of time, said transparent unit being affixed to packaging for a product and said solid material containing a non-random pattern.

2. The verification device according to claim 1, wherein the non-random pattern is one or more alphanumeric characters.

3. The verification device according to claim 1, wherein the non-random pattern is a logo.

4. The verification device according to claim 1, wherein the non-random pattern is made up of non-melting and unconnected elements forming a pattern within the solid material.

5. The verification device according to claim 1, wherein the non-random pattern is made of unconnected elements that melt at a rate differing from the rate at which the solid material melts.

6. The verification device according to claim 1, wherein the transparent unit is made of clear plastic.

7. The verification device according to claim 1, wherein the solid material melts when zero degrees centigrade has been exceeded for a specified period of time.

8. The verification device according to claim 1, wherein the transparent unit is affixed to the packaging for the product with an adhesive.

9. A verification device comprising a transparent unit containing solid material that melts into a liquid when a specified temperature has been exceeded for a specified period of time, said transparent unit being an integral part of packaging for a product and said solid material containing a non-random pattern.

10. The verification device according to claim 9, wherein the non-random pattern is one or more alphanumeric characters.

11. The verification device according to claim 9, wherein the non-random pattern is a logo.

12. The verification device according to claim 9, wherein the non-random pattern is made up of non-melting and unconnected elements forming a pattern within the solid material.

13. The verification device according to claim 9, wherein the non-random pattern is made of unconnected elements that melt at a rate differing from the rate at which the solid material melts.

14. The verification device according to claim 9, wherein the transparent unit is made of clear plastic.

15. The verification device according to claim 9, wherein the solid material melts when zero degrees centigrade has been exceeded for a specified period of time.
